(19) United States
(12) Patent Application Publication
(10) Pub. No.: US 2025/0097110 A1
(43) Pub. Date: Mar. 20, 2025

(54) AUTOMOTIVE SECURE DATA TRANSMISSION BETWEEN OVER-THE-AIR APPLICATION CONSUMER AND PROVIDER SOLUTION USING SCALABLE SERVICE-ORIENTED MIDDLEWARE OVER INTERNET PROTOCOL

(71) Applicant: FCA US LLC, Auburn Hills, MI (US)

(72) Inventors: Akshara Nallamala, Telangana (IN); Siva Krishna Kattinti, Telangana (IN)

(21) Appl. No.: 18/470,703

(22) Filed: Sep. 20, 2023

(51) Int. Cl. H04L 41/0869; H04L 41/14; H04L 43/50

(52) U.S. Cl. CPC H04L 41/0869; H04L 41/145; H04L 43/50

(57) ABSTRACT

A simulation and testing system for a communication network of a vehicle, the simulation and testing system including a computing system external to the vehicle and configured to execute a customized programming script to simulate at least one of client and provider servers for a scalable service-oriented middleware over Internet protocol (SOME/IP) network configuration for a plurality of electronic control units (ECUs) of the vehicle and test and verify operability of the SOME/IP network configuration by sending and verifying SOME/IP test messages between the computing system and at least some of the plurality of ECUs, and a control system for the communication network of the vehicle, the control system being configured to control communication between the plurality of ECUs via SOME/IP and via other communication protocols.

### FIELD

The present application generally relates to automotive communication control systems and, more particularly, to techniques for secure data transmission between over-the-air (OTA) consumer and provider using scalable service-oriented middleware over Internet protocol (SOME/IP).

### BACKGROUND

Today's vehicles often include a plurality of different electronic control units (ECUs) and are communication with each other and with remote servers, such as for over-the-air (OTA) updates and application communication. For example, vehicles could include tens or hundreds of different ECUs. Conventional vehicle communication protocols, such as the controller area network (CAN) (e.g., flexible-data rate CAN, or FD-CAN) and local interconnect network (LIN), are signal-oriented communication (SOC) protocols. SOC protocols have limited bandwidth, are only suitable for static systems (i.e., at the time of vehicle integration, with no future upgrades or updates), and data is communicated whenever there is an event, even if the receiver does not need the data, resulting in excessive data overhead in the communication channel. SOC protocols also do not ensure interoperability among different operating systems, embedded firmware, data interfaces, and application software. Accordingly, while such conventional vehicle communication systems do work for their intended purpose, there exists an opportunity for improvement in the relevant art.

### SUMMARY

According to one example aspect of the invention, a simulation and testing system for a communication network of a vehicle is presented. In one exemplary implementation, the simulation and testing system comprises a computing system external to the vehicle and configured to execute a customized programming script to simulate at least one of client and provider servers for a scalable service-oriented middleware over Internet protocol (SOME/IP) network configuration for a plurality of electronic control units (ECUs) of the vehicle and test and verify operability of the SOME/IP network configuration by sending and verifying SOME/IP test messages between the computing system and at least some of the plurality of ECUs, and a control system for the communication network of the vehicle, the control system being configured to control communication between the plurality of ECUs via SOME/IP and via other communication protocols.

In some implementations, the testing and verification of the SOME/IP test messages further comprises establishing a connection between a target ECU of the plurality of ECUs and the computing system using a wired or wireless communication protocol, requesting a SOME/IP connection between the target ECU and the computing system, receiving, by the computing system and from the target ECU via the SOME/IP connection, a packet, and in response to receiving the packet, sending, from the computing system and back to the target ECU via the SOME/IP connection, an acknowledgement. In some implementations, the testing and verification of the SOME/IP test messages further comprises receiving, by the computing system and from the target ECU via the SOME/IP connection, payload information, and verifying, by the computing system, successful communication via the SOME/IP connection when the payload information is within a desired format.

In some implementations, the wired or wireless communication protocol is Ethernet or WiFi. In some implementations, the customized programming script is a customized Python programming script. In some implementations, the simulation by the computing system is only of a subset of at least one of client and provider servers and does not include weighting of all SOME/IP modules. In some implementations, the customized programming script and the computing system are controlled by an original equipment manufacturer (OEM) of the vehicle. In some implementations, the computing system does not execute licensed third-party simulation and testing software. In some implementations, the testing and verification of the SOME/IP test messages is not dependent upon dynamic link library (DLL) files.

According to another example aspect of the invention, a simulation and testing method for a communication network of a vehicle is presented. In one exemplary implementation, the simulation and testing method comprises providing a computing system external to the vehicle, providing a control system for the communication network of the vehicle, executing, by the computing system, a customized programming script to simulate at least one of client and provider servers for a SOME/IP network configuration for a plurality of ECUs of the vehicle and test and verify operability of the SOME/IP network configuration by sending and verifying SOME/IP test messages between the computing system and at least some of the plurality of ECUs, and controlling, by the control system, communication between the plurality of ECUs via SOME/IP and via other communication protocols.

In some implementations, the testing and verification of the SOME/IP test messages further comprises establishing a connection between a target ECU of the plurality of ECUs and the computing system using a wired or wireless communication protocol, requesting a SOME/IP connection between the target ECU and the computing system, receiving, by the computing system and from the target ECU via the SOME/IP connection, a packet, and in response to receiving the packet, sending, from the computing system and back to the target ECU via the SOME/IP connection, an acknowledgement. In some implementations, the testing and verification of the SOME/IP test messages further comprises receiving, by the computing system and from the target ECU via the SOME/IP connection, payload information, and verifying, by the computing system, successful communication via the SOME/IP connection when the payload information is within a desired format.

In some implementations, the wired or wireless communication protocol is Ethernet or WiFi. In some implementations, the customized programming script is a customized Python programming script. In some implementations, the simulation by the computing system is only of a subset of at least one of client and provider servers and does not include weighting of all SOME/IP modules. In some implementations, the customized programming script and the computing system are controlled by an OEM of the vehicle. In some implementations, the computing system does not execute licensed third-party simulation and testing software. In some implementations, the testing and verification of the SOME/IP test messages is not dependent upon DLL files.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an example scalable service-oriented middleware over Internet protocol (SOME/IP) simulation and testing system for a communication network of a vehicle according to the principles of the present application; and

FIGS. 2-3 are dataflow and flow diagrams of an example connection establishment and SOME/IP test messaging and verification and an example SOME/IP simulation and testing method for a communication network of a vehicle according to the principles of the present application.

### DESCRIPTION

As previously discussed, today's vehicle communication networks are often based on signal-oriented communication (SOC) protocols, such as the controller area network (CAN), local interconnect network (LIN), and FlexRay. SOC protocols can still be utilized for low-end applications as they remain cost-efficient, well-tested, and robust. Diverse networks should be used in automobiles in order to provide different combinations of performance, cost, and features. Some issues with SOC protocols include limited bandwidth, suitability only for static systems (i.e., at the time of vehicle integration, with no upgrades or updates), and data being communicated whenever there is an event, even if the receiver does not need the data, resulting in excessive data overhead in the communication channel. SOC protocols also do not ensure interoperability among different operating systems, embedded firmware, data interfaces, and application software. Moving into the future, as vehicles become more complex (e.g., more electronic control units, or ECUs), vehicle communication networks will rely more heavily on Ethernet (e.g., TCP/IP and/or UDP) as a core communication protocol.

Compared to SOC protocols, an Ethernet-based vehicle network can provide a higher communication bandwidth for the communication traffic required by vehicle-to-everything (V2X) communication, high-performance sensors such as cameras and light detection and ranging (LIDAR), which are required for advanced driver-assistance (ADAS) and autonomous driving, and the human-machine interfacing (HMI) required by in-vehicle infotainment (IVI) systems.

An alternative to SOC protocols is a service-oriented architecture (SOA), and one newer automotive SOA protocol is the scalable service-oriented middleware over Internet protocol, also known as SOME/IP. SOME/IP is a middleware solution that enables service-oriented communication between vehicle ECUs. The ECU requesting data becomes the client, and the ECU providing the data becomes the server. In addition to faster communication over Ethernet, potential benefits of SOME/IP include dynamic communication as service request/response, a publish/subscribe mode followed by sending of data, only sending data when asked for by a node, and serialization of the data.

A SOME/IP based communication network requires unique network management software, which includes unique operating and scheduling algorithms. For example, a complex hybrid gateway could be necessary between the traditional SOC components/modules (CAN, LIN, FlexRay, etc.) and the Ethernet-based components/modules. Before implementation and integration on a production vehicle, the SOME/IP based communication network needs to be simulated and tested to verify its performance. Conventional simulation and testing solutions for SOME/IP based communication networks are licensed third-party software, which increases costs and testing difficulty for an original equipment manufacturer (OEM) due to a limited number of licenses and also limitations on operating systems that can run/execute the software. These simulation and testing tools are able to simulate the behavior of ECUs in a communication network. Two examples of these simulation and testing tools include CANoe (based on the communication access programming language, or CAPL) and the Automotive Network Diagnoser (ANDi).

As a result, the present application is directed to improved testing systems and methods for SOME/IP based communication networks in vehicles. These systems and methods utilize specially developed programming (e.g., Python) scripts and one or more external computer systems (e.g., laptop computers) to verify SOME/IP communication messages between the vehicle ECUs and the external computer system. In other words, the consumer and provider applications are effectively being “mocked up” using the external computer system(s). In addition to no longer needing licensed third-party software, there is no dependency on dynamic link library (DLL) files as the simulation/testing results. This customized solution also allows for the verification of SOME/IP communication messages between ECUs and the external computer system(s) using Ethernet or WiFi. There is also no need for weighting or consideration of all of the modules to be implemented from the development. In addition to being fully customized to the OEM's needs/desires, the proposed solution also saves costs by no longer needing the licenses for third-party simulation and testing tools and being able to run on any hardware (i.e., any operating system).

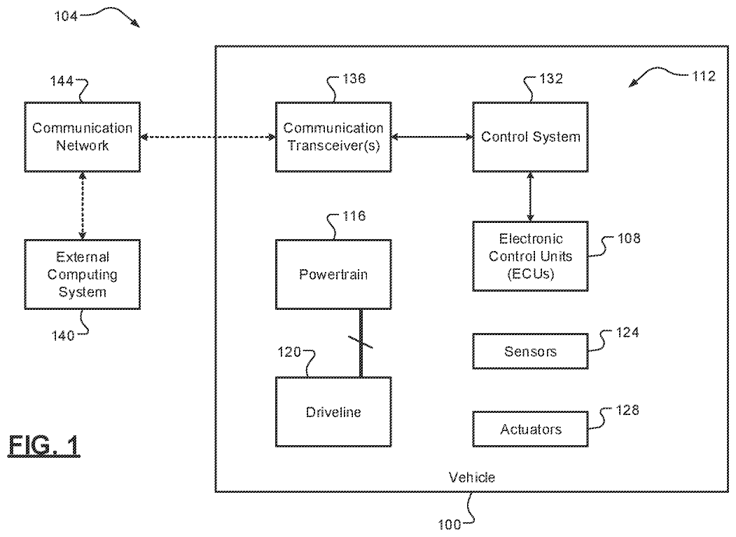

Referring now to FIG. 1, a functional block diagram of a SOME/IP simulation and testing system 104 for a communication network of a vehicle 100 according to the principles of the present application is illustrated. The vehicle 100 includes a plurality of electronic control units (ECUs) 108-1 . . . 108-N (where N is an integer greater than one; collectively, “ECUs 108”) in communication with each other and with remote devices via a vehicle communication network 112. The vehicle 100 also generally comprises a powertrain 116 configured to generate and transfer drive torque to a driveline 120 for vehicle propulsion.

The powertrain 116 could include any suitable components, such as, but not limited to, an internal combustion engine (ICE), one or more electric motors, one or more high voltage battery systems, and a transmission. The powertrain 116 could have any suitable torque generating configuration (ICE-only, ICE and electric motor(s), electric motor(s) only, etc.). The vehicle 100 also includes a set of sensor(s) 124, a set of actuator(s) 128, and a control system 132 for controlling operation of the vehicle 100. The control system 132 could be, for example, a supervisory ECU of the ECUs 108 or the control system 132 could be a supervisory communication/network controller of the vehicle 100.

The vehicle 100 also includes one or more communication transceivers 136 each configured for communication via a particular wired or wireless communication protocol or a particular plurality of communication protocols. For example, two of the communication transceivers 136 could be configured for wired Ethernet and wireless WiFi communication, respectively. It will be appreciated that the communication transceivers 136 could include interfaces for other (e.g., vehicle-specific) communication protocols, but this may not be required for the simulating and testing systems and methods of the present application as will be more fully described below.

As part of the techniques of the present application, an external computing system 140 (e.g. a laptop computer) is in communication with the control system 132 (via a communication network 144 and the communication transceivers 136) and is configured to execute a customized programming script (e.g., a Python script) to simulate a SOME/IP client/provider environment for testing and verification of SOME/IP messages.

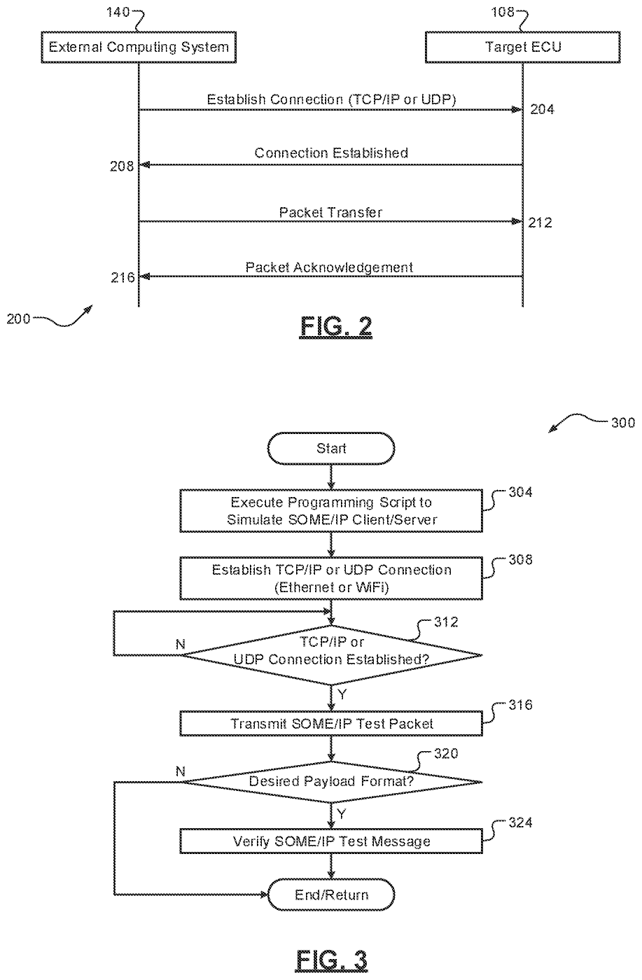

Referring now to FIG. 2, an example dataflow diagram 200 illustrating a process for establishing communication and a SOME/IP connection and subsequent SOME/IP test messaging and verification according to the principles of the present application is illustrated. In a first communication 204, the computing system 140 establishes wired Ethernet or wireless WiFi communication (e.g., via TCP/IP or UDP) with a target ECU 108 (of the plurality of ECUs 108). In a second communication 208, the target ECU 108 replies that the connection has been successfully established.

In a third communication 212, the computing system 140 sends a SOME/IP test packet to the target ECU 108. Upon receiving the SOME/IP test packet, the target ECU 108 replies with an acknowledgement of receipt in a fourth communication 216. Based on the payload information of the SOME/IP test packet (i.e., a format of the payload information), the SOME/IP test message and the simulated SOME/IP communication network is either verified or not verified, which is described in greater detail below.

Referring now to FIG. 3, an example SOME/IP simulation and testing method 300 for a communication network of a vehicle according to the principles of the present application. While the components of FIG. 1 are specifically references for illustrative/descriptive purposes, it will be appreciated that the method 300 could be applicable to any suitable vehicle/network. The method 300 begins at 304 where the computing system 144 executes the customized (e.g., Python) programming script to simulate at least one of client and provider servers for a SOME/IP network configuration for the plurality of ECUs 108.

At 308, the method 300 begins testing and verifying the operability of the SOME/IP network configuration. More specifically, at 308 the computing system 140 and the target ECU 108 establish a connection using a wired or wireless communication protocol (e.g., TCP/IP or UDP via wired Ethernet or wireless WiFi). At 312, the target ECU 108 detects for a confirmation or acknowledgement that the connection has been successfully established. When true, the method 300 proceeds to 316. At 316, the computing system 140 transmits a SOME/IP test packet (message) to the target ECU 108. At 320, the target ECU 108 determines whether the payload of the received packet is in a desired format (e.g., associated with SOME/IP). When false, the method 300 ends (i.e., no verification). When true, however, the SOME/IP test message is verified and the method 300 then ends or returns to 304 for one or more additional cycles.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

1. A simulation and testing system for a communication network of a vehicle, the simulation and testing system comprising:
a computing system external to the vehicle and configured to execute a customized programming script to:
generate a network simulation including at least one of client and provider servers for a scalable service-oriented middleware over Internet protocol (SOME/IP) network configuration for a plurality of electronic control units (ECUs) of the vehicle, and
using the network simulation, test and verify operability of the SOME/IP network configuration by sending and verifying SOME/IP test messages between the computing system and at least some of the plurality of ECUs; and
a control system for the communication network of the vehicle, the control system being configured to control communication between the plurality of ECUs via SOME/IP and via other communication protocols.

2. The simulation and testing system of claim 1, wherein the testing and verification of the SOME/IP test messages further comprises:
establishing a connection between a target ECU of the plurality of ECUs and the computing system using a wired or wireless communication protocol;
requesting a SOME/IP connection between the target ECU and the computing system;
receiving, by the computing system and from the target ECU via the SOME/IP connection, a packet; and
in response to receiving the packet, sending, from the computing system and back to the target ECU via the SOME/IP connection, an acknowledgement.

3. The simulation and testing system of claim 2, wherein the testing and verification of the SOME/IP test messages further comprises:
receiving, by the computing system and from the target ECU via the SOME/IP connection, payload information; and
verifying, by the computing system, successful communication via the SOME/IP connection when the payload information is within a desired format.

4. The simulation and testing system of claim 2, wherein the wired or wireless communication protocol is Ethernet or WiFi.

5. The simulation and testing system of claim 1, wherein the customized programming script is a customized Python programming script.

6. The simulation and testing system of claim 1, wherein the network simulation generated by the computing system is only of a subset of at least one of the client and provider servers and does not include weighting of all SOME/IP modules.

7. The simulation and testing system of claim 1, wherein the customized programming script and the computing system are controlled by an original equipment manufacturer (OEM) of the vehicle.

8. The simulation and testing system of claim 1, wherein the computing system does not execute licensed third-party simulation and testing software.

9. The simulation and testing system of claim 1, wherein the testing and verification of the SOME/IP test messages is not dependent upon dynamic link library (DLL) files.

10. A simulation and testing method for a communication network of a vehicle, the simulation and testing method comprising:
providing a computing system external to the vehicle;
providing a control system for the communication network of the vehicle;
executing, by the computing system, a customized programming script to:
generate a network simulation including at least one of client and provider servers for a scalable service-oriented middleware over Internet protocol (SOME/IP) network configuration for a plurality of electronic control units (ECUs) of the vehicle, and
using the network simulation, test and verify operability of the SOME/IP network configuration by sending and verifying SOME/IP test messages between the computing system and at least some of the plurality of ECUs; and
controlling, by the control system, communication between the plurality of ECUs via SOME/IP and via other communication protocols.

11. The simulation and testing method of claim 10, wherein the testing and verification of the SOME/IP test messages further comprises:
establishing a connection between a target ECU of the plurality of ECUs and the computing system using a wired or wireless communication protocol;
requesting a SOME/IP connection between the target ECU and the computing system;
receiving, by the computing system and from the target ECU via the SOME/IP connection, a packet; and
in response to receiving the packet, sending, from the computing system and back to the target ECU via the SOME/IP connection, an acknowledgement.

12. The simulation and testing method of claim 11, wherein the testing and verification of the SOME/IP test messages further comprises:
receiving, by the computing system and from the target ECU via the SOME/IP connection, payload information; and
verifying, by the computing system, successful communication via the SOME/IP connection when the payload information is within a desired format.

13. The simulation and testing method of claim 11, wherein the wired or wireless communication protocol is Ethernet or WiFi.

14. The simulation and testing method of claim 10, wherein the customized programming script is a customized Python programming script.

15. The simulation and testing method of claim 10, wherein the network simulation generated by the computing system is only of a subset of at least one of the client and provider servers and does not include weighting of all SOME/IP modules.

16. The simulation and testing method of claim 10, wherein the customized programming script and the computing system are controlled by an original equipment manufacturer (OEM) of the vehicle.

17. The simulation and testing method of claim 10, wherein the computing system does not execute licensed third-party simulation and testing software.

18. The simulation and testing method of claim 10, wherein the testing and verification of the SOME/IP test messages is not dependent upon dynamic link library (DLL) files.
